(19) United States
(12) Patent Application Publication
(10) Pub. No.: US 2014/0170605 A1
(43) Pub. Date: Jun. 19, 2014

(54) Reusable Adherent Labels and Related Methods

(71) Applicant: Goodbrella, LLC, Harker Heights, TX (US)

(72) Inventor: Gina M. Gatto-Weising, Harker Heights, TX (US)

(73) Assignee: Goodbrella, LLC, Harker Heights, TX (US)

(21) Appl. No.: 14/046,167

(22) Filed: Oct. 4, 2013

Related U.S. Application Data
(60) Provisional application No. 61/709,865, filed on Oct. 4, 2012.

(51) Int. Cl. G09B 21/02; G09F 3/10

(52) U.S. Cl. CPC G09B 21/02; G09F 3/10
USPC 434/113; 40/638

(57) ABSTRACT

Reusable, PSA labels and related methods. Some labels comprise a layer of PSA and an information layer. The PSA layer defines bond and exposed surfaces wherein the exposed surface is removable and bondable to contact surfaces. Additionally, the information layer defines exposed and bond surfaces wherein the exposed surface is able to receive a (removable) marking. The information layer is bonded to the layer of PSA. Labels can comprise Braille structures on the exposed surfaces of the information layer. Some reusable PSA labels comprise an intermediate adhesive layer so that the bonding is via the intermediate layer. If desired, the bond surfaces of the PSA layers can be on a sub-layer of the PSA layers and can have flow temperatures of no more than about 300 degrees Fahrenheit. Moreover, labels can have PSA layers that remain flexible at a temperature of about 20 degrees Fahrenheit.

### CROSS-REFERENCE TO RELATED APPLICATIONS

This application claims priority to U.S. provisional patent application No. 61/709,865 filed Oct. 4, 2012, by Gina M. Gatto-Weising, and titled Reusable Adherent Labels and Methods of Manufacturing the entirety of which is incorporated by reference as if set forth in full herein.

### BACKGROUND

Static cling labels are unreliable under kitchen and many other domestic/household conditions. Post-It® note-type stickers, moreover, do not have sufficiently robust and tacky adhesive to be reliable in the kitchen either. Yet many users still want to place notes on various objects, change those notes, reposition, and/or reuse those notes. Their reasons for doing so extend from the mundane (for instance, labeling leftovers in a refrigerator) to more critical applications (such as warning a diabetic that a container contains a sugar-containing product.) Indeed, the reasons are quite varied and even encompass the desire to train, educate, inform, etc. other users.

### SUMMARY

The following presents a simplified summary in order to provide an understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed disclosure that is presented herein. The current disclosure provides reusable PSA (pressure sensitive adhesive) labels and related systems, apparatus, methods, etc.

In accordance with embodiments, a reusable and repositionable PSA label for household use provides a relatively thin information-carrying top laminate layer and relatively thick adhesive polymer bottom layer. In specific embodiments the top information layer is attached to the bottom adhesive layer directly with the application of heat. Alternative embodiments attach the top information layer to the bottom adhesive layer with a middle layer of a second adhesive such as glue.

The polymer adhesive layer is prepared with the use of an adhesive that is selected from a group of suitable commercially available products. Preparation of the adhesive layer includes the step of applying heat to the commercial product on a flat surface until the commercial product melts into a flowing liquid so that the liquid flows and spreads across the flat surface to a desired thickness. The heat is removed and the liquid material is allowed to cool and solidify into a layer of uniform thickness. The adhesive layer is then ready to have the informational top layer applied to it.

Some embodiments provide reusable, pressure sensitive adhesive (PSA) labels. PSA labels of the current embodiment comprise a layer of pressure sensitive adhesive and an information layer. The pressure sensitive adhesive layer defines a bond surface and an exposed surface wherein the exposed surface is bondable with a contact surface when pressed there against in such a way that it can also be removed there from. Moreover, the information layer defines an exposed surface and a bond surface wherein the exposed surface of the information layer is able to receive a marking to convey information. The exposed surface of the information layer is also able to have the marking removed there from. Additionally, the information layer is bonded to the layer of pressure sensitive adhesive via the bond surfaces.

In various embodiments removing the marking from the PSA labels requires a solvent such as alcohol. PSA labels of some embodiments can further comprise a Braille structure on the exposed surface of the information layer. Moreover, some reusable PSA labels further comprise an intermediate adhesive layer disposed between the bond surfaces so that the bonding between the bond surfaces is via the intermediate adhesive layer. If desired, the bond surfaces of the pressure sensitive adhesive layers can be situated on sub-layers of the pressure sensitive adhesive layers having flow temperatures of between about 250 and 300 degrees Fahrenheit. Moreover, reusable PSA labels of various embodiments have pressure sensitive adhesive layers that remain flexible at a temperature of about 20 degrees Fahrenheit. Some reusable PSA labels display an image of a clock on the exposed surface of the information layer while some reusable PSA labels display an international “no” sign.

Embodiments provide methods of manufacturing reusable, PSA labels. These methods include various operations such as forming a layer of pressure sensitive adhesive which defines a bond surface and an exposed surface. Moreover, the pressure sensitive adhesive layer can be formed so that the exposed surface is removably bondable to a contact surface when pressed there against. Methods of the current embodiment also comprise forming an information layer defining an exposed surface and a bond surface. The information layer can be formed so that the exposed surface of the information layer is able to removable receive a marking to convey information. In accordance with the current embodiment, the methods also comprise bonding the information layer to the layer of pressure sensitive adhesive via the bond surfaces. Of course, if desired, the methods also include cutting the reusable PSA label from a blank.

To the accomplishment of the foregoing and related ends, certain illustrative aspects are described herein in connection with the annexed figures. These aspects are indicative of various non-limiting ways in which the disclosed subject matter may be practiced, all of which are intended to be within the scope of the disclosed subject matter. Other novel and nonobvious features will become apparent from the following detailed disclosure when considered in conjunction with the figures and are also within the scope of the disclosure.

### BRIEF DESCRIPTION OF THE FIGURES

The detailed description is described with reference to the accompanying figures. In the figures, the left-most digit(s) of a reference number usually corresponds to the figure in which the reference number first appears. The use of the same reference numbers in different figures usually indicates similar or identical items.

FIG. 1 illustrates a reusable PSA label.

FIG. 2 illustrates another reusable PSA label.

FIG. 3 illustrates a cross-sectional view of a reusable PSA label.

FIG. 4 illustrates another cross-sectional view of a reusable PSA label.

FIG. 5 illustrates still another cross-sectional view of a reusable PSA label.

FIG. 6 illustrates a top plan view of a blank of reusable PSA labels.

FIG. 7 illustrates a flowchart of a method of manufacturing and/or reusing reusable PSA labels.

### DETAILED DESCRIPTION

The current disclosure provides reusable PSA labels and related systems, apparatus, methods, etc.

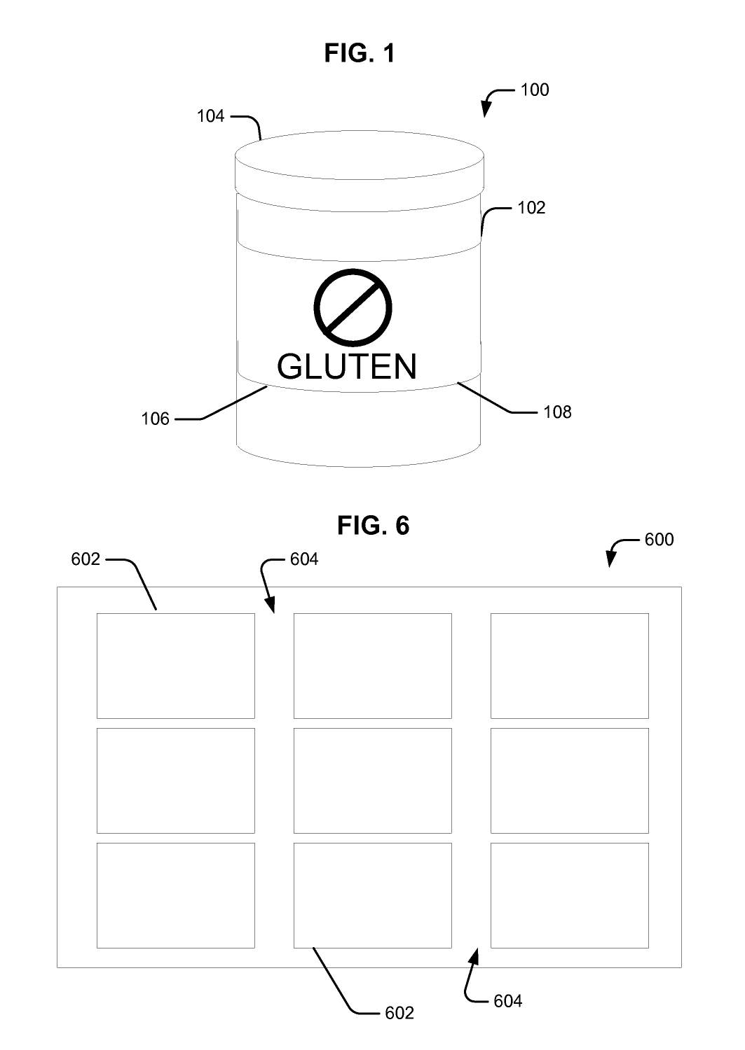

FIG. 1 illustrates a reusable PSA label. More specifically, FIG. 1 illustrates a container 100 which includes a body 102 and a lid 104. Additionally, FIG. 1 illustrates a reusable PSA label 106 removably bonded to the body 102 of the container. Notably, the reusable PSA label includes an informational display surface 108 which is exposed to the user and which carries some informational image, text, etc. on it.

The container 100 could be a jar, bowl, piece of Tupperware®, tin (or steel) can, box, pot, etc. Often the container holds food, drinks, condiments, etc. although many other types of contents are possible and within the scope of the current disclosure. Moreover, as those skilled in the art will appreciate, the container 100 might be opaque, translucent, or transparent. In addition, the container 100 might have a lid 104 although the container 100 could have a cap or some type of covering such as cellophane, Saran® wrap, tin foil, aluminum foil, etc. As a result, it might be inconvenient to view the contents of the container 100. Also, the container could be located (and/or movable) in a number of varying environments such as those found indoors, outside, in a refrigerator, in a cooler, in a tent, in a recreational vehicle (or other type of vehicle) etc.

In many situations, users might not want to, or be inclined to look inside the container 100 to determine its contents. Moreover, some users (such as those with mentally challenged, brain injuries, the blind, etc.) might have difficulty in discerning or understanding certain implications of what the contents might mean to them. For instance, the blind simply cannot see the contents whether they remove the lid 104 and/or whether the body 102 of the container 100 is transparent. Those users with mentally challenged conditions might not (even upon viewing the contents) appreciate the implications thereof. For instance, those with infantile or infant-like mental capacities and certain dietary issues might not understand that gluten-containing, lactose-containing, sugary, alcoholic, etc. contents might aggravate conditions such as gluten intolerance and/or celiac, lactose intolerance, diabetes, Crohn's Disease, peanut-related allergies, etc.

Further still, the contents of the container 100 might change over time. In some situations, parents of the foregoing types of individuals might place leftovers in the various containers 100 in a given refrigerator. Then again, even if the contents of a given container stay generally the same, certain impurities might find their way into the contents. For instance, a knife used to butter bread might taint butter with gluten or sugar might be added to a drink stored in a particular container.

With continuing reference to FIG. 1, the reusable PSA labels 106 of the current embodiment allow users to conveniently label and/or re-label containers 100 in accordance with circumstances and/or their desires. More specifically, the reusable PSA labels 106 illustrated by FIG. 1 can be bonded to such containers 100 by pressing the reusable PSA labels 100 against the containers 100 and allowing the pressure sensitive adhesive on the backs thereof to removably bond to the containers 100. Additionally, while some reusable PSA labels 100 have permanent images impressed thereon, some reusable PSA labels 100 can (removably) accept markings on their exposed surfaces. Indeed, some reusable PSA labels can have permanent images and can receive markings as well as have those markings removed therefrom. The removable markings can be made by pens, pencils, Sharpie® markers, whiteboard markers, highlighters, etc.

Still with reference to FIG. 1, the types of permanent information images for the reusable PSA labels of the current embodiment run the gamut of possible informational images. While not wishing to limit the disclosure, the Inventor has found that the following types of informational images can be advantageously displayed by reusable PSA labels of embodiments: dietary warnings, poison warnings, learning/educational messages, training messages, etc. Moreover, these images can be graphical, textual, or a combination thereof.

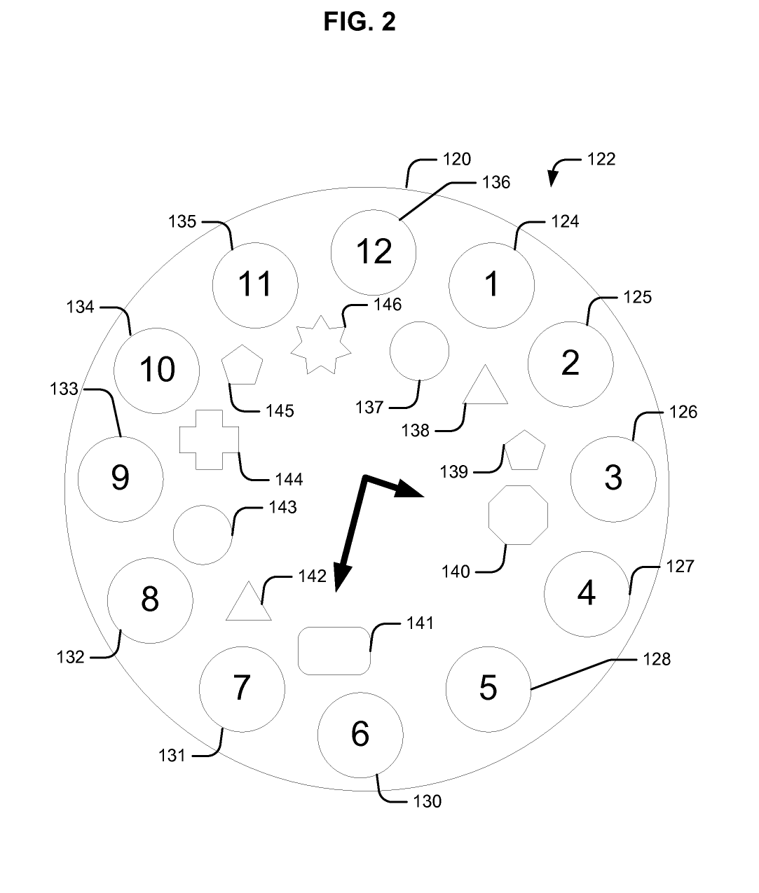

FIG. 2 illustrates another reusable PSA label. More specifically, FIG. 2 illustrates the reusable PSA label 120 and its informational area 122 which displays the image of a clock. The clock image, of course, includes icons 124-136 for each of the 12 hours typically displayed on a clock face although 24-hour (and/or other) types of clocks could be displayed in the informational area 122. In the current embodiment, though, the reusable PSA label 120 (with the clock image) can be used to train a child (whether developmentally challenged or not) to associate certain activities with certain times of the day. For instance, the reusable PSA label 120 could also include other reusable PSA labels 137-146 which can be applied to sectors of the clock image (corresponding to particular hours or times of day/night) and which display icons associated with pre-selected user activities. For instance reusable PSA label 140 displays a soccer ball associating soccer or some other athletic endeavor with the 3:00-4:00 time frame. Reusable PSA label 141, in contrast, displays a bathtub icon associating bath time with the 6:00-7:00 period. Thus, children with learning disabilities could be trained with an aid such as reusable PSA label 120.

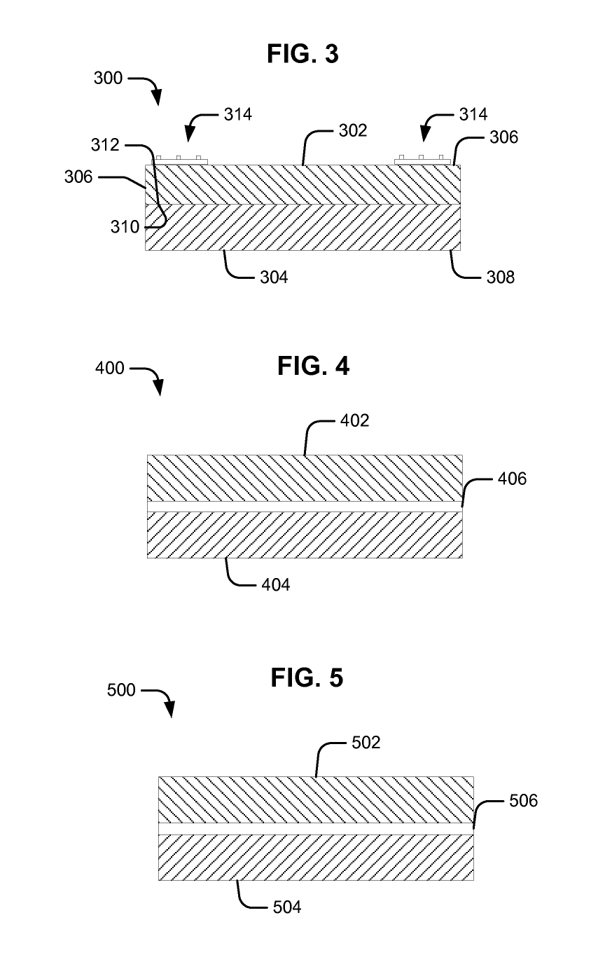

FIG. 3 illustrates a cross-sectional view of a reusable PSA label. More specifically, FIG. 3 illustrates that the reusable PSA label 300 generally includes two layers bonded to one another. The two layers of the current embodiment are the informational layer 302 and the pressure sensitive adhesive layer 304. The informational layer 302 can be made of any number of materials. For instance, a vinyl laminate, an acrylic laminate, etc. can be used to form the informational layer 302. Meanwhile, the pressure sensitive adhesive layer can be made of any type of pressure sensitive adhesive. In some embodiments that pressure sensitive adhesive is Gel Cling which is available from Impact Innovations, Inc. of Maynard, Minn. However, any pressure sensitive adhesive such as those which are based on certain elastomers (with an appropriate tackifier added thereto) will do for many applications. Pressure sensitive adhesives based on acrylics, butyl rubber, ethylene-vinyl acetate (EVA), natural rubber, nitriles, silicone rubbers, styrene block copolymers (SBC), styrene-butadiene-styrene (SBS), styrene-ethylene/butylene-styrene (SEBS), styrene-ethylene/propylene (SEP), and/or styrene-isoprene-styrene (SIS) could be used in reusable PSA labels of the current embodiment.

Moreover, as is further disclosed herein, the informational layer 302 and the pressure sensitive adhesive layer 304 can be bonded to one another. For instance, both layers 302 and 304 can define exposed surfaces 306 and 308 and bond surfaces 310 and 312 respectively. The bonding between the two layers 302 and 304 can be by way of the bond surfaces 310 and 312 leaving the exposed surfaces 306 and 308 available for other purposes. For instance, the exposed surface 308 of the informational layer 302 can display information, images, etc. while the exposed surface 312 of the pressure sensitive adhesive layer 304 can be used to adhere (even if temporarily) the reusable PSA label 300 to some object. For instance, Braille tape 314 can be applied to the exposed surface 306 of the informational layer 302 with the exposed surface 308 of the pressure sensitive adhesive layer 304 being used to adhere the reusable PSA label 300 to a food container.

FIG. 4 illustrates another cross-sectional view of a reusable PSA label. More specifically, in addition to layers 402 and 404 which are somewhat similar to layers 302 and 304, reusable PSA label 400 includes an intermediate layer 406 of adhesive. The adhesive used to form intermediate layer 406 of the current embodiment can be any type of glue and/or adhesive suitable to bond the bond surfaces of the layers 402 and 404 together. For instance, Amazing Goop adhesive (available from Eclectic Products, Inc. of Eugene, Oreg.) can be used to form the intermediate layer 406.

FIG. 5 illustrates still another cross-sectional view of a reusable PSA label. In this embodiment, the reusable PSA labels 500 include a sub-layer of the pressure sensitive adhesive layer 504. More specifically, the sub-layer 506 is formed from a pressure sensitive adhesive with a flow temperature between about 250 degrees Fahrenheit and about 300 degrees Fahrenheit and is used to bond the bond surfaces of the informational layer 502 and the pressure sensitive adhesive layer 504. Indeed, in accordance with embodiments, heat can be applied to the bond surface of the pressure sensitive adhesive layer 504 such that the sub-layer 506 softens or becomes amorphous, liquid, and/or semi-liquid or “flows” and thus becomes tacky. In some cases, that heat is applied by an (temperature controlled) iron or press for a pre-selected amount of time. The informational layer 502 is then applied to the sub-layer 506 and pressed against the same. Thus, in accordance with the current embodiment and as the sub-layer 506 cools, it bonds the bond surfaces of the layers 502 and 504 together. It might be worth noting that while FIG. 5 shows the sub-layer 506 as having a definite boundary with the remainder of the pressure sensitive adhesive layer 504, this feature does not limit the current disclosure. More particularly, it is believed that the “boundary” between the sub-layer and the remainder of the pressure sensitive adhesive layer 504 might be indeterminate, diffuse, ill-defined, etc. Yet, in reusable PSA labels of the current embodiment, some portion of the pressure sensitive adhesive layer 504 will have been “flowed” with a structure perhaps more uniform than the rest of the pressure sensitive adhesive layer 504 which reflects that “flow” history.

FIG. 6 illustrates a top plan view of a blank of reusable PSA labels. More specifically, FIG. 6 illustrates that the blank 600 includes numerous labels 602 surrounded by borders 604. These blanks 600 of the current embodiment can be mass-produced with one or more types of labels 602 embodied therein or they can be produced in more limited volumes containing only one (or a few) type(s) of label 620. Moreover, these blanks 600 can be scored, perforated, etc. so as to allow relatively easy separation of one or more individual labels 602 from the blank 600.

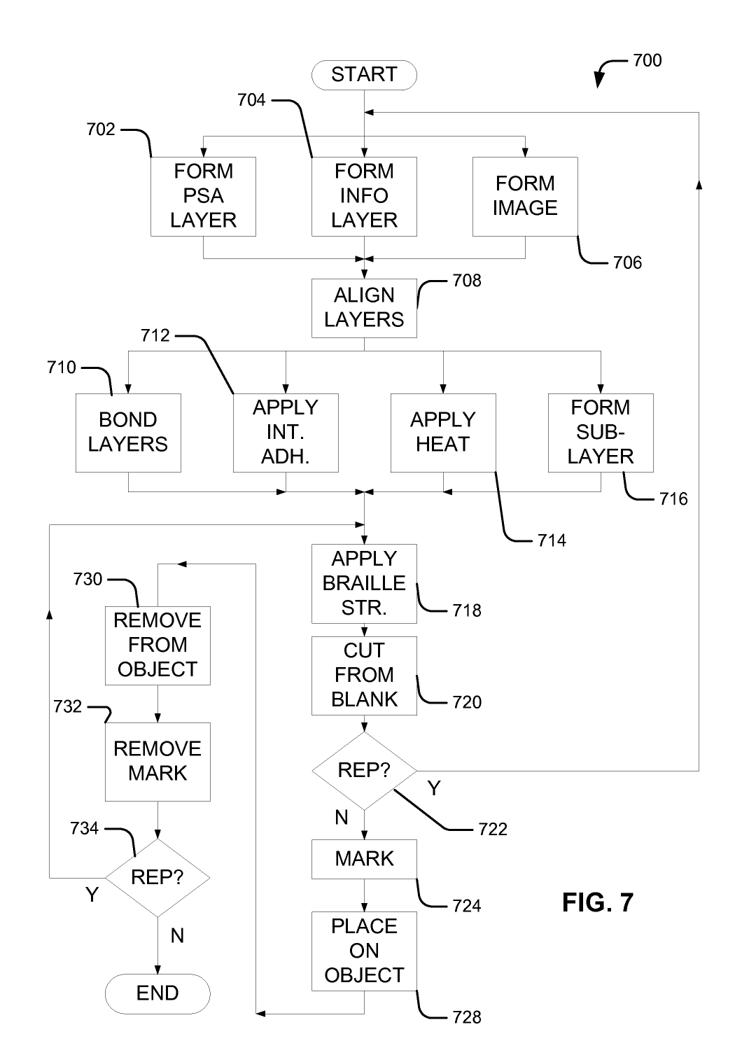

FIG. 7 illustrates a flowchart of a method of manufacturing and/or reusing reusable PSA labels. More specifically, FIG. 7 illustrates that the method 700 includes various operations such as forming a layer of pressure sensitive adhesive. See reference 702. At about the same time, if desired, an informational layer 502 of one or more labels 602 (or blanks 600) can be formed as indicated at reference 704. Of course, as the informational layer 502 is being formed, an image(s) can be embodied therein or imprinted thereon. See reference 706.

Furthermore, the two layers 502 and 504 can be aligned with each other as illustrated by reference 708. Once aligned, or perhaps at some other time, the layers 502 and 504 can be bonded with one another. See reference 710. That bonding can be by way of the application of adhesive or heat to the informational layer (with heat being conducted to the sub-layer 506 of the pressure sensitive adhesive layer 504) and/or subsequent pressing of the two layers 502 and 504 together. See references 712 and 714 respectively. Of course, the adhesive and/or heat could be applied to the pressure sensitive adhesive layer 504 instead of (or in addition to) the informational layer 502 without departing from the scope of the current disclosure. In scenarios in which heat is used to bond the layers 502 and 504 to each other, the sub-layer 506 can be formed at reference 716.

At some point, a Braille structure such as Braille tape 314 can be applied to the informational layer 502 of one or more labels 602. See reference 718. While FIG. 7 illustrates application of a Braille structure to the informational layer during the manufacture of the label(s), this ordering (as with other ordering-related information disclosed with reference to method 700 and elsewhere herein) is non-limiting. For instance, the Braille structure could be applied to the informational layer at any time in method 700 if desired.

However, in accordance with the current embodiment, FIG. 7 does illustrate that method 700 includes cutting (or otherwise separating) one or more labels 602 from a blank 600 of labels. See reference 720. Moreover, as indicated by reference 722, some or all of the foregoing portions of method 700 can be repeated if desired. Of course, though, method 700 can continue with other operations.

For instance, a user could mark one or more of the labels 602 at reference 724 and/or could place one or more labels 602 on various objects at reference 726. In keeping with the reusable and/or repositionable nature of some such labels 602, users could also remove such labels 602 from these objects. See reference 728. Additionally, or in the alternative, the users could remove the label 602 from an object and/or move it to another location as indicated at reference 730. In addition, or in the alternative, a user could remove the marking(s) from one or more labels 602 as reference 732 shows. Moreover, additional labels of various embodiments can be manufactured and used in accordance with method 700 and/or other methods. See reference 734. In some situations, though, method 700 could end if desired.

Thus, repositionable/reusable adherent labels of embodiments have been disclosed. Such labels allow users to conveniently mark and/or remark containers and/or other objects in many environments including homes, offices, factories, etc. Labels of various embodiments, moreover, facilitate various activities such as training, educating, warning, informing, etc. users of/for certain conditions and/or activities in flexible, convenient, and/or inexpensive manners. Labels of embodiments can be removably applied to a wide range of objects and under a wide range of circumstances.

In accordance with embodiments, a reusable and repositionable PSA label for household use provides a relatively thin information-carrying top laminate layer and relatively thick adhesive polymer bottom layer. In specific embodiments the top information layer is attached to the bottom adhesive layer directly with the application of heat. Alternative embodiments attach the top information layer to the bottom adhesive layer with a middle layer of a second adhesive such as glue. Of course, terms such as “top,” “bottom,” “back,” “front,” etc. are used herein merely for convenience and do not limit labels of the current embodiment to use in any particular orientation or position.

The polymer adhesive layer of the current embodiment is prepared with the use of an adhesive that is selected from group of suitable commercially available products. Preparation of the adhesive layer includes the step of applying heat to the commercial product on a flat non-stick surface until the commercial product melts into a flowing liquid so that the liquid flows and spreads across the flat surface to a desired and substantially uniform thickness. The adhesive layer is then ready to have the informational top layer applied to it. The heat is removed and the liquid material is allowed to cool and solidify into a layer of uniform thickness with a label adhered to the top. Excess adhesive is trimmed around the edge of the top label after the adhesive has cooled and solidified. Suitable commercially available adhesive products include without limitation gel cling which is available from Impact Innovations, Inc.

In some embodiments, an adhesive sticker provides a relatively thin top layer, cut from a vinyl laminate or flexible plastic sheet a few millimeters in thickness (for instance) and attached to a relatively thick bottom adhesive layer about ⅛ inch thick. Information is displayed on the top surface of layer. With some sticker-like embodiments of the labels, the information is pre-printed on the plastic layer. With some embodiments, information is provided by the user with either a permanent or erasable marker, or with some other suitable indicator, even braille tape and the like.

In another embodiment, an adhesive sticker provides a relatively thin top layer cut from a vinyl laminate or flexible plastic sheet and attached to a relatively thick bottom adhesive layer by means of an intermediate adhesive such as glue. One suitable intermediate adhesive is Amazing Goop® by Eclectic Products Inc., of Eugene, Ore.

Moreover, labels of some embodiments can adhere around curved surfaces as well as sharper corners (such as 90 degree corners). Labels of embodiments also, or in the alternative, adhere to surfaces typically encountered in the household and therefore are suitable for use with freezer-compatible containers and refrigerator-compatible containers.

The following are illustrative embodiments of various sticker and labels, how they are manufactured and suggested uses.

Label Basics of Some Embodiments:

Labels of the current embodiment comprise a thermoplastic adhesive such as Gel Cling (white) that has been melted and cooled; white or clear vinyl laminate sheet; a contact adhesive such as “Amazing Goop” (clear/transparent) acrylic paint (for its artwork); Braille tape (for use in creating Braille labels); and printed art work of various pictures (as visual aids for learning and project calendars with, for instance, a star indicating an element of surprise or a picture of a lunch box illustrating lunch time, etc.)

Template Labels of Some Embodiments:

Labels of the current embodiment comprise gel cling adhesive (bottom layer) which is glued to a laminate template (top informational layer) that has an acrylic design (information) displayed on the top. Use of the template label (in accordance with the current embodiment) enables the user to place it on any glass, plastic, stainless steel, box etc. surface for storage in refrigerator, freezer or pantry with the name/date of food or product to be used in the present or future (for instance leftover pot roast with a notation such as “pot roast Sep. 4, 2012”). Template labels can have various designs to accompany most any decor.

Template labels of the current embodiment allow easier access to previously prepared foods stored in a pantry, a freezer and/or a refrigerator. They also can enable user(s) to know what has been prepared and when it was prepared and allows them greater ease in learning this information without having to open the container(s). Labels of the current embodiment are reusable, repositionable, and easy to clean with soap and water. Moreover, these labels can be written on with dry or wet markers. These label are flexible and wrap around the corners of containers with adhesive which is sufficiently strong to maintain contact with the container.

Learning & Kitchen Labels:

In accordance with the current embodiment, some labels comprise: cling gel adhesive glued to printed or painted pictures as visual aids. Labels of the current embodiment can be somewhat similar to the foregoing template labels however labels of the current embodiment can use vinyl laminate or other material for the top of the label, sticker, photo paper, plastic, etc.

Learning Purpose:

Labels of some embodiments are designed to help children or adults who learn better through pictures and/or users who want easier access to prepared foods for younger kids, especially those with food allergies. Labels of the current embodiment adhere to glass, plastic, stainless steel, boxes, and/or anything with a smooth surface i.e. jars, containers, boxes, plates, etc.

Learning Labels can be customized for the user who wishes to use the labels for a learning-clock or learning-calendar. Labels of the current embodiment are customized based on what the user desires for instance with a 24 hour clock label the user might want breakfast, lunch and dinner labels, bath labels, (reminders for a) specific sporting event or practices, specific labels that show surprise, change, homework, or specific tasks. Each label of the current embodiment can be placed on specific positions on the clock (or calendar) corresponding to specific times for instance daily, weekly, monthly, etc. and/or changes thereto.

Kitchen Purpose:

Labels of the current embodiment are designed for the kitchen (in the pantry, fridge, freezer, and/or in locations where entertaining occurs). These labels can be similar to the Template Labels. But they can have specific artwork or prints on their front surfaces showing what is in the container and/or dish. For instance a container holding a steak would have a picture of steak so a young child would know that steak was in the container. In another scenario, when hosting a party, a guest would see that steak was provided as one of the dishes being served.

For the user with a food over it could be placed on things in the pantry, refrigerator, and/or freezer containing that the user is allergic to.

Braille Label:

Labels of the current embodiment comprise cling gel adhesive, Braille tape (with user-selected wording) based on a picture/artwork on a vinyl laminate. In the current embodiment, the cling gel adhesive is glued to a vinyl laminate with Braille tape placed in between the two. Acrylic paint or printed art work could be added to the vinyl laminate to form a Braille label of the current embodiment

Braille Purpose:

Labels of the current embodiment can be used as visual aides and/or tools for caretakers and their charges. These labels can be designed for greater ease in the kitchen around meal and/or at other times. Reusable labels of the current embodiment can be used in the pantry, refrigerator, freezer, and/or other locations around the home, office, etc. They can be decorative and can be used to label containers with specific foods or food group pictures. Such labels can also be made with Braille messages for easier use by the visually impaired user. Moreover, labels of the current embodiment can save time and simplifies meal times for users.

Labels of many embodiments can be assembled by the application of heat and/or adhesives as disclosed elsewhere herein. In accordance with embodiments, which employ heat, gel cling is heated to about 250-300 degrees until it appears to become a soft liquid. The information layer of the label (for instance, a vinyl laminate) is then placed on the gel cling thereby covering the gel cling. The informational layer can be slightly pressed down until it feels sealed. Then, in accordance with the current embodiment, the heating device can be removed from the label thereby allowing the label to cool. Excess glue, gel cling, laminate, etc. can be trimmed from the label of the current embodiment.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts described herein are disclosed as illustrative implementations of the claims.

1. A reusable, pressure sensitive, adhesive (PSA) label comprising:
a layer of pressure sensitive adhesive defining a bond surface and an exposed surface and being flexible at a temperature of about 20 degrees Fahrenheit, the exposed surface having a property of being removably bondable to a contact surface when pressed there against;
a sub-layer of the pressure sensitive adhesive layer wherein the bond surface of the pressure sensitive adhesive layer is situated on a sub-layer of the pressure sensitive adhesive layer having a flow temperature of between about 250 and about 300 degrees Fahrenheit;
an information layer defining an exposed surface and a bond surface, the exposed surface of the information layer having the properties of being able to receive a marking to convey information and being able to have the marking removed there from, the information layer being bonded to the layer of pressure sensitive adhesive via the bond surfaces; and
a Braille structure on the exposed surface of the information layer.

2. A reusable, pressure sensitive, adhesive (PSA) label comprising:
a layer of pressure sensitive adhesive defining a bond surface and an exposed surface, the exposed surface having a property of being removably bondable to a contact surface when pressed there against; and
an information layer defining an exposed surface and a bond surface, the exposed surface of the information layer having the properties of being able to receive a marking to convey information and being able to have the marking removed there from, the information layer being bonded to the layer of pressure sensitive adhesive via the bond surfaces.

3. The reusable PSA label of claim 2 wherein the property of being able to have the marking removed requires a solvent.

4. The reusable PSA label of claim 3 wherein the solvent is alcohol.

5. The reusable PSA label of claim 2 further comprising a Braille structure on the exposed surface of the information layer.

6. The reusable PSA label of claim 2 further comprising an intermediate adhesive layer disposed between the bond surfaces whereby the bonding between the bond surfaces is via the intermediate adhesive layer.

7. The reusable PSA label of claim 2 wherein the bond surface of the pressure sensitive adhesive layer is situated on a sub-layer of the pressure sensitive adhesive layer having a flow temperature of between about 250 and about 300 degrees Fahrenheit.

8. The reusable PSA label of claim 2 wherein the pressure sensitive adhesive layer is flexible at a temperature of about 20 degrees Fahrenheit.

9. The reusable PSA label of claim 2 wherein the exposed surface of the information layer displays an image of a clock.

10. The reusable PSA label of claim 2 wherein the exposed surface of the information layer displays an image of an international “no” sign.

11. A method manufacturing a reusable, pressure sensitive, adhesive (PSA) label, the method comprising:
forming a layer of pressure sensitive adhesive defining a bond surface and an exposed surface, the exposed surface having a property of being removably bondable to a contact surface when pressed there against;
forming an information layer defining an exposed surface and a bond surface, the exposed surface of the information layer having the properties of being able to receive a marking to convey information and being able to have the marking removed there from; and
bonding the information layer to the layer of pressure sensitive adhesive via the bond surfaces.

12. The method of claim 11 wherein the property of being able to have the marking removed requires a solvent.

13. The method of claim 12 wherein the solvent is alcohol.

14. The method of claim 11 further comprising forming a Braille structure on the exposed surface of the information layer.

15. The method of claim 11 further comprising forming an intermediate adhesive layer disposed between the bond surfaces whereby the bonding between the bond surfaces is via the intermediate adhesive layer.

16. The method of claim 11 wherein the bond surface of the pressure sensitive adhesive layer is situated on a sub-layer of the pressure sensitive adhesive layer having a flow temperature of between about 250 and about 300 degrees Fahrenheit.

17. The method of claim 11 wherein the pressure sensitive adhesive layer is flexible at a temperature of about 20 degrees Fahrenheit.

18. The method of claim 11 further comprising forming an image of a clock on the exposed surface of the information layer.

19. The method of claim 11 further comprising forming an image of an international “no” sign on the exposed surface of the information layer displays.

20. The method of claim 11 further comprising cutting the PSA label from a blank.
